(19) United States
(12) Patent Application Publication
(10) Pub. No.: US 2008/0033847 A1
(43) Pub. Date: Feb. 7, 2008

(54) Asset inventory system

(76) Inventor: Anne Pell McIntosh, Homestead, FL (US)

Correspondence Address: Robert J. Van Der Wall;Gables One Tower, Penthouse Suite 1275, 1320 South Dixie Highway, Coral Gables, FL, 33146, US

(21) Appl. No.: 11/498,350

(22) Filed: Aug. 4, 2006

(51) Int. Cl. G06Q 10/00

(52) U.S. Cl. 705/28

(57) ABSTRACT

The present invention is for a system that delivers to owners of real and personal property a service to photographically inventory assets for a variety of purposes, including specifically to document the property for insurance claim purposes following damage or destruction or other loss resulting from hurricanes, tornadoes, floods, earthquakes, theft and/or fire. Other purposes include to document the condition of property after a catastrophic event, to show before and after comparisons regarding such events, to facilitate architect and homeowner communications on various issues, to allow an absentee owner to monitor reconstruction after damage or loss has occurred, to allow an absentee owner to make design or remodeling changes during repair, to view landscaping to make similar decisions, for a contractor to document building stages completion for draws, for use by governmental agencies such as local building and zoning departments or FEMA showing compliance with building codes or flood insurance restrictions, to show security measures, and the like.

### BACKGROUND OF THE INVENTION

1. Field of the Invention

The present invention relates to the field of proving assets before a catastrophic event such as a hurricane and/or a tornado by taking a photographic inventory of a physical premises such as a home or residence. More specifically it concerns a method or system of performing a service, primarily targeting homeowners, to create a photographic and recorded vocal record of the structure and entire contents of a residence using virtual tour technology such as used in the realtor industry. A primary purpose is to establish an inventory for insurance purposes. That inventory may also include the photographic and scanned documents' reproduction of available receipts for the construction, modification, expansion, or improvement of the structure, and/or the acquisition of personal property contained on the real estate within or without the structure.

While the inventive system is primarily intended to focus on real estate, it is equally well suited to inventory personal property, such as yachts and aircraft owned by a user of the inventive system. After the photographic inventory is assembled, it is then reduced to a computer readable Compact Disc or CD, and may also be listed on an internet website for remote access by insurance claims personnel, or reduced to other forms that retain the information in a safe and accessible form.

2. Description of the Prior Art

Coastal areas of the southeastern continental United States have been seen in recent years to be particularly vulnerable to hurricanes. Large segments of the plains states are often referred to as “tornado alley” because of the frequency of killer tornadoes. Many areas of the northern, central and eastern United States are subject to river flooding. Some areas of the western United States, particularly California, are prone to earthquakes. Virtually every one is subject to the risks of fire and theft. In each of these “events” there is usually a need to document what was owned before the catastrophe took place in order to make a full and proper claim for insurance coverage. There are also a variety of other purposes for such an inventory, such as to document the condition of property after a catastrophic event, to show before and after comparisons regarding such events, to facilitate architects' recommendations to various parties, for architects to show panoramic views of various designs, for architects and homeowners to confer regarding remodeling or rebuilding decisions, to allow an absentee owner to monitor reconstruction after damage or loss has occurred, to allow an absentee owner to make design or remodeling changes during repair, to view landscaping to make similar decisions, for a contractor to document building stages completion for draws, for use by governmental agencies such as local building and zoning departments or FEMA showing compliance with building codes or flood insurance restrictions, to show security measures, to document the personal property of users of the invention including such things as computers, televisions, and stereo systems, valuable art works, jewelry, antiques, furs, rugs, and collectibles, antique furniture, yachts and aircraft, including showing engines, avionics and navigation equipment, antique trucks and cars showing the license, model, interior and exterior condition as well as the engine and mechanics under the hood, motorcycles showing all specialty equipment, design, and custom paint, items that will be gifted in an estate, recording specific details, such as serial numbers, signatures, and certifications, appraisals, insurance policies with agent addresses and phone numbers, family treasures, and homeowner provided history using a voice recording function of the equipment, or use by other governmental agencies absent the context of a homeowner, such as a Department of Transportation in permitting and accepting contractors' work product in regard to road, bridge, traffic lights and similar public works, showing of hazards needing correction, or use by Departments of Environmental Protection for review, permitting, and accepting flood areas both prior to and following an event, for review, permitting, and accepting barrier protection, seawall and retaining walls, drainage, sewer systems, water systems, use of the system absent the context of a homeowner, such as by hurricane preparedness groups, and weather station emphasis on hurricane supplies and readiness, and to provide the perfect housewarming gift.

It is well known that most homeowners keep grossly inadequate records of what they have acquired in their homes, especially if they have resided in the same home for twenty or thirty years or more. Some casualty insurance companies caution their policyholders to document the contents of their homes because homeowners casualty insurance policies and renters insurance do provide coverage for lost or damaged contents. But there has historically been no easy way to accomplish this, and even those few percent of people who have good records often retain those records in the home where they are subject to the same catastrophic event as the other contents of the home. So far as is known to the present inventor, there has never been available to homeowners a service that will for a fee prepare a photographic and recorded vocal inventory of the premises structure and entire contents of a home or residence, and to store that inventory on a CD that can be placed in off premises safekeeping, such as a safe deposit box in a bank or on a remote access internet website.

At the same time, the realtor industry has developed sophisticated techniques for showing residences for sale on the internet using what is referred to as “virtual tours.” In effect, a party shopping to purchase improved real estate is able to examine the external and internal appearance of a large number of listed homes in a short period of time without leaving the comfort of their own home or office, and without the loss of time incurred in traveling from the geographical location of one listing to that of another, and so on. These virtual tours are aimed at enhancing the appearance of a listing to make them as attractive as possible. Professional photographers are used in worthy situations to take a large number of still photographs. These photographs can then be “stitched” together to make panoramic images of the exterior and each of the rooms in the interior. Software is used to accomplish that and it is referred to as “stitching software.” Because the business of selling improved real estate involves so many more specifications than what the listed premises look-like inside and out, the technology that accompanies the virtual tours used in the realtor industry is heavily burdened down with means of acquiring, assembling and communicating all of the relevant specifications that cannot be photographed except in written form. For purposes of the present invention, most of that burden is discarded. In its place is substituted much more detailed photography as will be seen hereinafter. For example, in the present invention, it is not enough to take a picture of a cabinet or a desk. The contents of each drawer must be shown as well, including making documents legible in the photographs.

A search of the prior art has yielded a number of references, but none seem especially relevant. The first reference is Morse et al., U.S. Pat. No. 6,839,880 for an Electronic Property Viewing System for Providing Virtual Tours Via a Public Communications Network, and a Method of Exchanging the Same. It is a very comprehensive system with 72 sheets of drawings and an 85 page appendix. Another reference is Wise et al., U.S. Pat. No. 6,985,902 for a Method, System and Apparatus for Creating and Accessing a Hierarchical Database in a Format Optimally Suited to Real Estate Listings. This is an example of the prior art that is burdened down with acquiring, assembly and communicating of specifications in exhaustive detail. A similar real estate reference is Florance et al., U.S. Pat. No. 6,871,140 for System and Method for Collection, Distribution and Use of Information in Connection with Commercial Real Estate. A prior art reference that is more relevant than the foregoing references is Jongerius, U.S. Patent No. 6,563,529 for an Interactive System for Displaying Detailed View and Direction in Panoramic Images. It indicates camera position, direction, and field of view using a map, and concerns pictures of real estate exteriors and interiors. It basically uses maps to explain the content of individual still photographs.

In summary, the prior art known to the present inventor includes some aspects of how the inventive system would acquire the photographic inventory, but it appears to be lacking the purpose of the present invention. The prior art therefore appears to lack a number of the relevant steps to achieve the desired results of the present invention.

### SUMMARY OF THE INVENTION

Bearing in mind the foregoing, it is a principal object of the present invention to provide a system that delivers to owners of real and personal property a service to photographically inventory assets for a variety of purposes, including specifically to document the property for insurance claim purposes following damage or destruction or other loss resulting from hurricanes, tornadoes, floods, earthquakes, theft and/or fire.

Another principal purpose of the present invention is to provide a system that delivers to owners of real and personal property a service to photographically inventory assets for such other purposes as to document the condition of property after a catastrophic event, to show before and after comparisons regarding such events, to facilitate architects' recommendations to various parties, for architects to show panoramic views of various designs, for architects and homeowners to confer regarding remodeling or rebuilding decisions, to allow an absentee owner to monitor reconstruction after damage or loss has occurred, to allow an absentee owner to make design or remodeling changes during repair, to view landscaping to make similar decisions, for a contractor to document building stages completion for draws, for use by governmental agencies such as local building and zoning departments or FEMA showing compliance with building codes or flood insurance restrictions, to show security measures, and the like.

An additional object of the invention is to document the personal property of users of the invention including such things as computers, televisions, and stereo systems, valuable art works, jewelry, antiques, furs, rugs, and collectibles, antique furniture, yachts and aircraft, including showing engines, avionics and navigation equipment, antique trucks and cars showing the license, model, interior and exterior condition as well as the engine and mechanics under the hood, motorcycles showing all specialty equipment, design, and custom paint, items that will be gifted in an estate, recording specific details, such as serial numbers, signatures, and certifications, appraisals, insurance policies with agent addresses and phone numbers, family treasures, and homeowner provided history using a voice recording function of the equipment, and the like.

A further object of the invention is for use by other governmental agencies absent the context of a homeowner, such as a Department of Transportation in permitting and accepting contractors' work product in regard to road, bridge, traffic lights and similar public works, showing of hazards needing correction, or use by Departments of Environmental Protection for review, permitting, and accepting flood areas both prior to and following an event, for review, permitting, and accepting barrier protection, seawall and retaining walls, drainage, sewer systems, water systems, and the like.

An additional object of the invention concerns use of the system absent the context of a homeowner, such as by hurricane preparedness groups, and weather station emphasis on hurricane supplies and readiness, and the like.

Another object of the invention is to provide the perfect housewarming gift, a necessity that many new homeowners may not even realize they need until it is too late. The gift is presented in the form of a gift certificate so that the homeowner can create the inventory they want and coordinate the schedule.

Other objects and advantages will be apparent to those skilled in the art upon reference to the following descriptions and the appended claims.

In accordance with a primary aspect of the invention there is provided a system for the use of property owners to deliver a service that documents and inventories assets as of a certain date in time. The system contemplates the use of still photographs that are stitched together using a computer based stitching program that creates panoramic views of each structure and each room in a structure, as well as of details concerning the contents of various things such as furniture and cabinets, garage, storage rooms and basements in the manner of virtual tours as used in the real estate sales industry. The invention further includes establishing an inventory for insurance purposes. That inventory may also include the photographic reproduction of available receipts for the construction, modification, expansion, or improvement of the structure, and/or the acquisition of personal property contained on the real estate within or without the structure.

In accordance with a second aspect of the invention, there is provided a system to inventory personal property, such as yachts and aircraft owned by a user of the inventive system.

In accordance with another aspect of the present invention a photographic inventory is assembled, it is then reduced to a computer readable media such as a Compact Disc or CD, and may also be listed on an internet website for remote access by insurance claims personnel, or reduced to other forms that retain the information in a safe and accessible form.

In accordance with a further aspect of the invention, a potential user of the inventive system contacts the system operator, who is then visited by a representative of the system operator at the location of the premises to be inventoried to assess the size of the property, the number of rooms, and the number of additional photos requested. Pricing information is initially based on the square footage of the premises, i.e., 3,000 square feet or less, 3,000 square feet-4,900 square feet, 4,900 square feet-8,000 square feet, or 8,000 square feet or greater. As part of the pricing process, the system operator also has a representative to access the local governmental subdivision property appraiser's website or office records to obtain the square footage on record and any other maps, floor plans, or layouts that are available. Any pertinent floor plans or layouts are downloaded or copied and saved to the file to be included in the tour. Custom inventory packages are priced according to the number of additional photos requested in addition to the square footage and number of rooms.

A written proposal is furnished to the owner prior to photography. The proposal also stipulates the process, the square footage, the number of additional photos and any details that are pertinent to the shoot. The proposal is signed by the system operator's representative as well as the property owner. The proposal includes the property's unique account number. Should an owner request an expedient shoot, the system operator has the capability to quote the job and photograph the same day.

In accordance with one more aspect of the present invention, the system contemplates a series of primary steps. These can be briefly described as follows: responding to an inquiry by a potential user by visiting the site of asset(s) or premises to be inventoried and providing an estimate to the property owner and taking an application, determining how many additional photographs need to be taken of such things as the contents of desks, filing cabinets and other kinds of cabinets, art works, receipts, certifications, appraisals, insurance policies with agent addresses and phone numbers, and other documentation, accessing the individual county real property appraiser's website or records to obtain the square footage on record and any other maps, floor plans, or layouts that are available, downloading any pertinent floor plans or layouts and saving them to the file to be included in the inventory, calendaring and conducting the photography of the premises and its contents in accordance with the instructions from the owner, downloading the photographs, using the stitching program to make the inventory by uploading the result to the Visual Tour website and editing the same, preparing a CD, packaging same, and delivery thereof to the property owner along with a brochure and an instruction letter to the owner concerning what should be done with the owner copies of the CD. Finally there are a series of minor steps that include maintaining the security of the property owner, viewing instructions, use of the Ozona Online Network, etc.

### DETAILED DESCRIPTION OF THE PREFERRED EMBODIMENTS

As required, detailed embodiments of the present invention are disclosed herein; however, it is to be understood that the disclosed embodiments are merely exemplary of the invention which may be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure.

In response to an inquiry from a potential user, an application is provided to the property owner through mail, fax, e-mail, or the system operator website. The owner is asked to furnish the square footage of the property and the number of rooms as well as point out any special items that should be noted. The owner is asked a preference for scheduling the shoot. Upon receipt of a completed or partially completed application, a representative from the system operator visits the property to determine the size of the property, the number of rooms, and the number of additional photos requested. A written estimate is furnished to the owner prior to photography. The estimate is in the form of a proposal which stipulates the process, the square footage, the number of additional photos and any details that are pertinent to the shoot. The proposal is signed by the system operator representative as well as the property owner. The proposal includes the property's unique account number. When an owner requests an expedient shoot, the system operator has the capability to quote the job and photograph the premises on the same day. The basic inventory priced according to the square footage of the property and the number of rooms. The price brackets are:
3,000 square feet or less
3,000 square feet-4,900 square feet
4,900 square feet-8,000 square feet
8,000 square feet or greater
   As part of the pricing process, a system operator representative accesses the individual county appraiser's website to obtain the square footage on record and any other maps, floor plans, or layouts that are available. Any pertinent floor plans or layouts are downloaded and saved to the file to be included in the inventory. Custom inventory packages are priced according to the number of additional photos requested because inventories can be customized to a property owner's specifications. Extra photos can be taken at request, additional voice narration can be included, and any additional documentation can be scanned and added to the inventory. For an additional fee, a detailed written inventory is provided. This inventory is categorized by room and includes any dates, prices, serial numbers, certifications, etc. that an owner can provide. The written inventory is preferably produced in MS Word and saved to the client's computer file to be included in the inventory CD.

An absentee owner is asked to give permission for access to the property. If there is a security gate, the property owner is asked to make the necessary arrangements for entrance. The system operator also supplies a form to be signed by a homeowner for entrance through a security gate. If keys are held by a security office or property manager, the owner is asked to give permission for key pick up. The technician provides a key sign-in and sign-out sheet to be signed by the technician as well as the keeper of the keys. This form is in addition to any key sign-out sheet required by security or a property manager.

Proper licensing is obtained before work begins. All city, county, and state requirements are met. The system operator's representatives travel throughout the United States providing inventory services as needed.

The date of the shoot is set on the camera before the shoot begins. The select date imprint and record time modes are set so that the date is imprinted on the photos. The photographer dictates the date and time-in and time-out into the camera's voice recording system. The date is very important to prove inventory and repairs. The time-in and time-out is an important part of inventory system security plan.

With the use of a digital camera, 1.5-megapixel CCD or higher, the system operator's photographer takes numerous photos of the interior and exterior of a home. Each photo overlaps so that they can be seamed together without omitting any portion of a room. The room can be shown item-by-item, section-by-section, 90, 180 or 360 degrees. This panoramic view enables the owner to recall inventory, as well as act as proof to an insurance company. The photographer/technician stands in a central position in each room, turning slightly, with each photo overlapping 20%. The photos are preferably taken from left to right.

With the use of the vibration reduction feature on the camera, panoramic photos are usually taken without the need of a tripod. However, tripods are used when necessary. In such cases, the tripod is placed in the center of the room and turned at regular intervals so that each photo overlaps slightly. The scene mode or panoramic mode on the camera assists the photographer in capturing the 360 degree virtual image. A fraction of the photo is superimposed allowing the next photo to overlap with the previous. The flash of the camera normally produces enough light, however, drapes are opened and lights turned on when necessary. Additional spotlights or high-powered flashes are also used when needed.

The display mode on the camera displays the photo on the monitor so that the photographer can review photos while on site to determine the quality and content. The photographer retakes photos if needed, eliminating the need for a return visit. The playback-zoom feature of the camera is used to review close-ups. If unclear, any photo is retaken so that brands and serial numbers are clear. Using the delete feature on the camera, the technician deletes imperfect or unnecessary photos. On-site editing improves the finished product as well as improves efficiency. The system operator's technicians carry an extra charged battery for their camera and all other equipment. The system operator's cameras also have increased memories with 1-gigabyte memory cards added to avoid running out of storage space during a shoot.

Photos are routinely taken of storm shutter systems because these dated photos can be used as proof that proper precautions were taken before a hurricane. Since many seasonal homes are shuttered during the summer, additional lighting may be necessary. When the hurricane season ends, and the shutters are removed, an owner can request a second shoot. The photographic inventory is dated to show not only the shuttered property but also the home's windows and doors. Photos are also taken of the insides of cabinets, drawers, buffets, armoires, entertainment centers, closets, garages, etc. to show contents. Particular details of computers, televisions, and stereo systems are recorded. The owner may specify individual photos of valuable artwork, jewelry, antiques, furs, rugs, and collectibles.

Photos of individual items are taken with a zoom lens to depict serial numbers, labels, signatures or other identifying marks. The photographer zooms-in on the camera when necessary to make an item appear larger. This feature also facilitates close up shots. Photos are taken of the alarm equipment, being careful not to include a shot of the alarm panels or their locations. This detail is intentionallly excluded to give the property owner additional security. Should the owner have receipts for specific items, the receipts are photographed as well. The camera's copy mode provides clear images of black and white text. The system operator's technicians are also equipped with a portable scanner similar to Pentax Dsmobile USB. The USB power/data interface eliminates the need for an external power adapter. The system operator has the capability to scan documents from 2″×4″ to 8½′ to 14″. The documents scanned can be instantly saved to a laptop. Receipts, certifications and closed permits are scanned and downloaded into the computer and incorporated into the photographic inventory. Appraisals or any other certifications of jewelry or antiques and insurance policies with agent addresses and phone numbers may be scanned. The photographer dictates specific details into the camera's voice recording system, and playback voice memos to check for accuracy. He or she has the option to delete and correct voice memos.

The photographer photographs the interior of the garage to show any special tools or equipment, such as generators, humidifiers, lawnmowers, edgers, and boating equipment. All vehicles, golf carts, and bicycles are photographed. So are golf clubs, fishing and hunting gear, boats, motors, trailers, and davits. Heating and air conditioning systems as well as water purification systems also photographed. All pool equipment, patio furniture, barbecues, exercise and weight-lifting equipment are documented.

If an owner has copies of receipts and closed permits for building repairs or remodeling a photo image is taken or the items are scanned, whichever method produces the best result. The proof of repair, for insurance purposes, is the burden of the homeowner. Also, at resale, it may be necessary to furnish the buyer with copies of closed permits and proof of proper repair.

Offices and other commercial facilities are also treated similarly to a home inventory, taking precautions to record all office equipment, computers, fax machines, copy machines, telephone equipment, files, supplies, furnishings, artwork, etc. The same is true for museums, art galleries, specialty stores, and antique shops. The inventory can include up to 50 scenes.

When the photo shoot is complete, the technician opens a new file folder on his or her computer or laptop. The folder is named by the system operators's corresponding account number. The camera is connected to the computer through the use of properly interfaced cables. The photos are then downloaded from the digital camera into the computer and saved to the appropriately named file.

Scanned images are saved into the file folder as well. All scanned documents are saved as jpg files so that they can be uploaded to the inventory. During the inventory designing process, the scanned images are attached as a hot spot to a photo or as a stand-alone document.

At this point, the technician may design the inventory sequence or e-mail the electronic file folder to a designer. The designer computer includes Windows 98 or greater, 750 MHz processor, video card capable of displaying 65,000 colors or more, 128 MB memory, 100 MB of free hard disk space, and Internet Explorer 5.0 or greater. The designer uses a stitching program, similar to Visual Tours (www.visualtours.com), to arrange the photographs in groups that are selected for the stitching process. To upload a photo shoot to Visual Tour, the system operator technician connects to the internet, opens the Visual Tour site, opens the inventory, and sends it to Visual Tour. The system operator provides the inventory a title which is it's user account number.

The stitching program then seamlessly joins the photos automatically aligning heights and merging colors. As in photographing, photos are stitched from left to right. The software further levels the images. Photos are stitched vertically when necessary to show balconies, second floors, staircases, and lofts. Most photos are stitched horizontally to capture the contents of a room. Images can be rotated when necessary. Manual adjustments are made to the brightness, contrast or sharpness to provide an accurate portrayal of the property. A panoramic scene can be turned into a still photo, if necessary. Scene captions can be changed or updated. The order of images can be changed.

The inventory sequence begins by showing the outside grounds and entry of a home or office. The viewer is walked through the front door and into each individual room. Red hot spots are created at various locations to indicate an additional view and close-up photos are attached to these hot spots. Also photos made with the zoom lens are attached to show brand names, serial numbers, certifications, or signatures. Scanned documents are attached to additional red hot spots to create a third or fourth layer of proof. Red dots on a cabinet door, drawer, bureau, entertainment center, closet, etc. indicate there is an interior view. An additional click on the interior shot, allows an even closer view to verify the brand, serial number, or certification of the item or items. In addition to the two viewing options of normal or large, there are zooming capabilities. An item can be zoomed-in for a close up to examine fine details or zoomed-out for a broader view. The photo file is copied for use in the inventory. Original photos remain in the original file for safekeeping. When the designer completes the inventory, he or she e-mails a copy to the system operator for safekeeping, where it is saved in electronic files. Each property's unique account number titles each of these files. The files are saved in account number order for easy retrieval. Distribution of an inventory only occurs through client authorization.

The photographic inventory begins so that it runs continuously throughout the various rooms at 360 degrees with the option to stop at any room or at any hot spot for a closer look. The designer chooses the rotating speed of the inventory to allow enough time to review each room. Included is a gallery of individual photos labeled by location (ex: living room, dining room, bedroom 1, etc.). The labels are visible only when the mouse is placed over the photo. When the mouse is double clicked in this position, the photo enlarges. Written descriptions, history, brand names, serial numbers, etc. are detailed in a comment section under each photo group or scene. Music is added to the inventory and through the use of a microphone, the inventory is voice narrated with specific details. A computer with speakers thus allows a viewer to enjoy music and voice narration of brand name, serial number, history, or any other specific details.

The inventory is then branded with system operator's service mark and trade name and with a photo of the technician/photographer of the inventory. The inventory is then dated with the date of the photo shoot. This date is very important proof to an insurance company as previously pointed out. The designer then selects the send to CD option. The inventory title is entered. The system operator logo and address is then branded on the CD as well as the technician's photo. All contents in the edited file are then copied to the CD.

Once the edited inventory is downloaded on a CD, the system operator's label is affixed to the CD. For security and privacy, the label reflects an account number rather than the property address. The CD is placed in a DVD/CD plastic storage case. Through the use of labeling software, LABELWHIZ or similar, a paper sleeve is printed with system operator name and the account number. The paper sleeve is printed in book format so that the binder can be identified on a bookshelf. The label is then be placed in the cover-to-cover plastic sleeve.

The property owner receives two copies of the CD in a delivery package. Additional copies can be requested. However, the owner is allowed to copy the CD as desired. A return receipt of delivery is ordered. When the system operator receives the signed receipt, it is scanned and saved to the client's electronic file. All pertinent correspondence or documentation is saved to this record to allow for an accurate paperless system.

The delivery package includes an instruction letter. It suggests that a copy of the CD be downloaded to the owner's computer where it can be safely backed up and stored. A warning is attached to the CD's indicating that CD-ROM's should not be played back on audio CD equipment because playing CD-ROM's on an audio CD player could cause damage to the equipment. It also recommends that one copy of the CD should be placed in a bank safety deposit box. Another copy should be kept with other important documents and insurance policies. One more copy could be e-mailed to a relative of the client for safekeeping. The client is instructed to double click red hot spots for additional photos, close-up photos, or documentation and to provide that information to insurance claims representatives. By selecting appropriate command buttons, the inventory owner can print individual photos, share the inventory with family members, insurance claims representatives, or insurance agents, and e-mail the system operator's office. Also included with the delivery package is a brochure with all contact information and a mini CD with a sample inventory for tutorial purposes. Finally, the delivery package includes a post card which asks for comments, suggestions, or names of any individual or company that the client believes may be interested in the services of the system operator.

For viewing the actual inventory, the property owner is instructed to place the CD in a computer CD drive. The CD runs on any Windows or Mac computer having a CD tray. No special computer programs are required for viewing. The inventory begins in a continuous room-by-room mode as described in regard to the photography and editing. Again, whenever a red dot appears, the mouse should be placed on the dot and clicked. Red dots on a cabinet door, drawer, bureau, entertainment center, closet, etc. indicate there is an interior view. An additional click on the interior shot, allows an even closer view to verify the brand, serial number, or certification of the item or items. In addition to the two viewing options of normal or large, there are zooming capabilities. An item can be zoomed-in for a close up to examine fine details or zoomed-out for a broader view.

A URL (Uniform Resource Locator) address of the inventory is provided to the client to log into the inventory from the internet without the need of the provided CD. The URL address, of course, is the location of the inventory file. The client is also able to provide the URL address to his or her insurance claims representative or agent for their easy access. This process eliminates the need of e-mailing an attachment or mailing a copy of the CD.

What follows are some of the details of the system operator's method of managing the system and its interaction with users, contractors and computer service provider to the system operator. The latter is presently Ozona Online Network, Inc., www.oztek.net, who among other things back up the system operator's office computers daily. The backups are stored on Ozona's secure server indefinitely, which is monitored 24 hours a day, 7 days a week. The backup reserve energy comes an automatic battery/diesel generator system. Thus, Ozona operates with no power interruption. Ozona provides the system operator with continuous monitoring for fire and security, a FM200 fire control system, dual air conditioning systems, dual 100 Meg Ethernet connections to the internet, diverse carrier connections with Verizon, TW and UUNet, Cisco ONS 15454 Optical Network System with OC48 Fiber Ring, duel Cisco 7206VXR with NPE300 processor 1200 mbps capacity, multiple Hewlett-Packard Intel and Compaq dual and Quad CPU servers running raid 5 SCSI drives, Cisco catalyst series switches, full gigabit and fast Ethernet local LAN connections, and APC extended UPS Systems for 50,000 VA. Ozona also hosts the system operator's website.

The system operator maintains calendars for scheduling appointments with a separate calendar for each technician. Appointments are made by the system operator and logged into the individual calendars. Through the use of the system operator's website, technicians access their e-mail, notices, and calendars. Each technician is given a unique code which gives them entrance to the back door of the website. This centralized system facilitates communication between the field technicians and the office of the system operator allowing coordination of schedules at all times.

Technicians travel with laptops that have a wireless connection to the internet which enables the technician to monitor e-mail and schedules efficiently. Technicians also have the ability to send and receive faxes through their laptops. If documentation is needed in the field, a faxed authorization can eliminate delays.

The system operator coordinates shoots in the same vicinities when possible allowing it to keep costs down and to be time efficient. Through the use of the Web, technicians, designers, and administration can coordinate and distribute the workload. Once the photos are downloaded, they can be e-mailed to a designer to create the inventory. The designer can be located throughout the United States. When it is time to create a CD and package it for delivery, another associate, located anywhere in the United States, can assist. The coordination of work through the Web allows flexibility, efficiency in staffing, and the quickest possible delivery to the client.

A centralized address book is kept in a shared file, which is accessible on-line. This book contains addresses, home and office phone numbers, cell numbers, fax numbers, and e-mail addresses for technicians and suppliers. This is used as a company directory. Clients are not included in this directory.

With the use of phones, e-mail, and the internet, technicians and designers are able to work from home, except for that which must be done at client premises. Voice mail, call forwarding, and cell phones allow technicians and designers to work in the field or at home as needed. This system allows easy message retrieval from any location and eliminates the space limit problem experienced with answering machines. Technicians download directions to the property from a program similar to MapQuest before travel. Technicians also use navigation systems in their vehicles or use a portable navigator.

Complete personnel files are kept on all technicians. The file includes a copy of their driver's license, current automobile insurance cards, and automobile registration. Background checks are ordered on all technicians and designers and the results maintained in their personnel files.

Technicians and Designers are independent contractors. They provide W-9's before beginning work and receive 1099's at the end of each year for payment received. They are paid a percentage of each inventory. The out of pocket costs of an inventory are deducted before calculation of technician and designer compensation. The system operator pays all expenses through its operating bank account.

Technicians and designers receive on-site training. They are shown the proper format and steps for producing an accurate inventory, and are given the opportunity to work with someone until they have achieved confidence and competence. An important part of their training is accomplished with training manuals. Each manual gives step-by-step assistance to either technician/photographers or designers. Each manual includes detailed instructions, photos, and outlines. The manuals are updated as needed. The manuals are also on-line for easy reference. The technician or designer can simply log onto the system operator website and access the back door of the website with his or her individual code to enter the training manual, such as can be done in the field using his or her laptop.

Each inventory is assigned a unique account number. The number begins with alphabetical characters depicting the photographer's identity, the year produced, the last 4 digits of the zip code of the property, and finally a sequential number. An example is dk2006303701, which can be interpreted as Dave Kennedy, year 2006, zip code 33037, 01 for the first assigned number.

A secured list of account numbers, with matching property addresses, is safely protected at the system operator's office. The account numbers and the physical addresses of the properties as well as the property owner's name is kept in a spreadsheet. For privacy and security, this list is not only not made public, but it is not accessible by anyone other than the accounting department of system operator.

In addition to protecting a homeowner's privacy and security through system operator's discrete account numbering process and avoiding the location or images of the alarm panels, the system operator is bonded by Platinum Insurance and Bonds, Inc. and has obtained a million dollar liability policy from “A” rated, Burlington Insurance Company. The system operator includes a key sign-in and out sheet for the photo shoot, which also acts as another confirmation of the shoot date. Deleting data on memory cards or the camera's built-in memory does not completely erase original data. Deleted data can sometimes be recovered using specialty software. Ensuring the security of client data is very important. Therefore, data is erased using commercial deletion software or the memory is formatted and completely refilled with images of the floor or a blank wall. The system operator uses Nova Development's Drive Erase Pro software for this purpose. This software erases data from memory cards as well as PC's.

The system operator requires the client to sign a release should the client request their inventory be furnished by the system operator to a third party because the system operator will not provide the client's inventory to the third party without written permission.

Invoices are produced through QuickBooks Pro. The invoice is mailed to the client at his or her billing address, if it is dated before the shoot. If after, the remaining balance due invoice is normally enclosed in the delivery package. The reference number is the account number assigned to the property. The physical property is also identified in the invoice in case a property owner has ordered multiple tours of multiple properties. If the owner prefers, an invoice may be e-mailed or faxed. Payment is accepted in the form of cash, checks, cashier's checks, money orders and charge cards. Visa or MasterCard charge cards are processed through QuickBooks Pro. A down payment of one-half of the estimate at the time of the shoot is expected and the balance is billed at completion. The final bill is normally included in the delivery package.

A written receipt is produced through QuickBooks Pro, acknowledging payment, date of payment, and method of payment. The receipt is mailed, e-mailed, or faxed to the billing address provided. The receipt references the property's account number as well as the physical address.

The system operator maintains a website detailing its services, outlining basic inventory price schedules, describing the company, showing sample inventories, listing testimonies, offering an application form, providing contact information, and furnishing a link to the system operator's information e-mail address. The system operator sends its brochure to anyone requesting more information from the website, and communicates through e-mail, phone, fax, or mail to answer specific questions. That includes sending an introduction letter and our brochure to referrals. With authorization, mailings are sent to homeowners in private resorts.

While the invention has been described, and disclosed in various terms or certain embodiments or modifications which it has assumed in practice, the scope of the invention is not intended to be, nor should it be deemed to be, limited thereby and such other modifications or embodiments as may be suggested by the teachings herein are particularly reserved especially as they fall within the breadth and scope of the claims here appended.

What is claimed is:

1. A client asset inventory system comprising:
assessing what is to be inventoried by observation and communication with the client;
agreeing with the client on a scope of the inventory;
photographing the asset(s)/premises in accordance with the scope agreed to produce a multiplicity of digital photographs;
photography of assets being inventoried;
stitching together at least some of the photographs to create panoramic images;
editing the photographs to produce a photographic inventory of the asset(s); and
furnishing the inventory to the client.

2. The system of claim 1 in which assessing what is to be inventoried comprises determining how many additional photographs need to be taken of such things as contents of desks, filing cabinets and other kinds of cabinets, art works, receipts, certifications, appraisals, insurance policies with agent addresses and phone numbers, and other documentation.

3. The system of claim 1 which further comprises:
visiting a site of asset(s)/premises to be inventoried;
supplying the client with a proposal for an inventory; and
reaching agreement with the client on a scope of the inventory.

4. The system of claim 1 which further comprises:
accessing any available local governmental real estate appraiser's website/records to obtain premises square footage on record and any other maps, floor plans, and layouts that are available; and downloading any pertinent such information and saving it to a file to be included in the inventory.

5. The system of claim 1 which further comprises responding to an inquiry by a potential client by taking an application from the potential client.

6. The system of claim 1 which further comprises visiting a site of asset(s)/premises to be inventoried and providing a proposal with a price for the inventory to an owner of the asset(s)/premises.

7. The system of claim 1 wherein stitching together at least some of the photographs to create panoramic images is accomplished by uploading the desired photographs to a Visual Tour website to process the photographs thereat.

8. The system of claim 1 which further comprises using a zoom lens in the photography to show brand names, serial numbers, certifications, and details on documents including signatures, art works, and other personal property.

9. The system of claim 1 in which editing includes:
adding red hot spots to the inventory at various locations to indicate additional views of close-up photos;
adding scanned documents to the inventory; and
adding red hot spots to the inventory to indicate the location of the scanned documents.

10. The system of claim 9 which further comprises scanning documents into a laptop computer carried by a technician performing the photography.

11. The system of claim 9 in which the editing further comprises adding a zoom function to inventory facilitating viewing such that an item can be zoomed-in for a close up to examine fine details or zoomed-out for a broader view.

12. The system of claim 1 which further comprises adding an audio component to the inventory such as by a recorded vocal record
made by a technician performing the photography.

13. The system of claim 1 which further comprises:
following a catastrophic event, revisiting a site of asset(s)/premises to be reinventoried to create a before and after comparison;
assessing what is to be reinventoried by observation and communication with the client;
agreeing with the client on a scope of the reinventory;
photographing the asset(s)/premises in accordance with the scope agreed to produce a multiplicity of digital photographs;
stitching together at least some of the photographs to create panoramic images;
editing the photographs to produce a photographic reinventory of the asset(s); and
furnishing the reinventory to the client.

14. The system of claim 1 wherein the client is an architect who uses the inventory to confer with a property owner regarding at least one of reconstruction after a catastrophe, remodeling and additions, and landscaping.

15. The system of claim 1 wherein the client is a contractor who uses the inventory to confer with an absentee property owner regarding at least one of proving completion of construction, to document building stages completion for draws, discussion of proposed additions, and discussion of proposed remodeling.

16. The system of claim 1 wherein the client is a governmental agency such as local building and zoning departments, and FEMA showing compliance with such things as building codes and flood insurance restrictions, to show security measures, a Department of Transportation in permitting and accepting contractors' work product in regard to road, bridge, traffic lights and similar public works, showing of hazards needing correction, and Department of Environmental Protection for review, permitting, and accepting flood areas both prior to and following an event, for review, permitting, and accepting barrier protection, seawall and retaining walls, drainage, sewer systems, and water systems.

17. The system of claim 1 wherein the client is a friend of new homeowners who purchases a gift certificate from the system operator as a housewarming gift to the new homeowners so that the homeowners can create the inventory they want and coordinate the schedule and scope of the inventory.

18. A client asset inventory system comprising:
visiting a site of asset(s)/premises to be inventoried;
assessing what is to be inventoried by observation and communication with the client;
supplying the client with a proposal for an inventory;
reaching agreement with the client on a scope of the inventory;
photographing the asset(s)/premises in accordance with the scope agreed to produce a multiplicity of digital photographs;
stitching together at least some of the photographs to create panoramic images;
editing the photographs to produce a photographic inventory of the asset(s);
copying the photographic inventory to a computer media; and
furnishing the computer media with the inventory to the client with viewing and storage instructions.
